(19) United States
(12) Patent Application Publication
(10) Pub. No.: US 2005/0149258 A1
(43) Pub. Date: Jul. 7, 2005

(54) Assisting navigation of digital content using a tangible medium

(76) Inventor: Ullas Gargi, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/752,786

(22) Filed: Jan. 7, 2004

(51) Int. Cl. G01C 21/30

(52) U.S. Cl. 701/208; 701/211; 340/995.14

(57) ABSTRACT

Techniques are disclosed for creating a tangible medium containing digital content, and using the tangible medium to navigate corresponding files stored on a computer device. A user can use an input device to move about the tangible medium, and make a selection therefrom. A computing device determines which of the stored files contain digital content corresponding to the user's selection, by using pattern matching, coordinate mapping, or other techniques. The stored file is retrieved, and the digital content is made available for navigation.

### BACKGROUND

When navigating voluminous digital content (e.g., text, image, video, etc.), it is often useful to have an independently accessible overview of the content. For example, when navigating within a detailed digital map of San Francisco, one may wish to know where a particular street is located relative to the city as a whole. Conversely, when looking at a city overview, one may want to explore in detail certain streets in a particular neighborhood identified from the overview.

In the current state of the art for displaying an overview together with a detailed portion thereof, both images are displayed on a computer screen. For example, a map of a particular neighborhood may be displayed in a first computer window, and a map of the entire city may be displayed in a second computer window. To go from the detailed view to the overview, the user can either toggle back and forth between the two windows, or configure them for simultaneous display (with a corresponding reduction in size). This is often inconvenient or awkward.

Thus, a market exists for improved techniques for navigating digital content.

### SUMMARY

An exemplary method for assisting navigation of digital content using a tangible medium comprises: receiving an instruction to access digital content corresponding to a portion of a tangible medium, said medium being readable by a user-positionable input device, and said digital content being accessible from a stored file; determining and accessing digital content corresponding to the user's instantaneous position on the tangible medium; and enabling electronic navigation of the digital content. The tangible medium may have been previously created using the specific digital content actually tangible on the medium, or may have been created using different digital content. Other embodiments and implementations are also disclosed.

### BRIEF DESCRIPTION OF THE FIGURES

FIG. 1 illustrates an exemplary operating and computing environment for implementing exemplary embodiments described herein.

FIG. 2 illustrates an exemplary process for generating a tangible medium.

FIG. 3 illustrates an exemplary process for navigating digital content using a tangible medium.

FIG. 4 illustrates an exemplary process for determining digital content corresponding to a user-specified portion of the tangible medium.

FIG. 5 illustrates another exemplary process for determining digital content corresponding to a user-specified portion of the tangible medium.

FIG. 6 illustrates an exemplary tangible medium including a series of mode identifiers, each of which represents two possible types of motion.

### DETAILED DESCRIPTION

I. Overview

Exemplary improved techniques for navigating a digital content are described herein.

Section II describes an exemplary operating and computing environment for implementing exemplary embodiments described herein.

Section III describes an exemplary process for generating a tangible medium.

Section IV describes an exemplary process for navigating a document using a tangible medium.

Sections V, VI and VII describe exemplary processes for determining digital content corresponding to a user-specified position on the tangible medium.

Section VIII described other aspects and considerations.

II. An Exemplary Operating and Computing Environment

A. An Exemplary Operating Environment

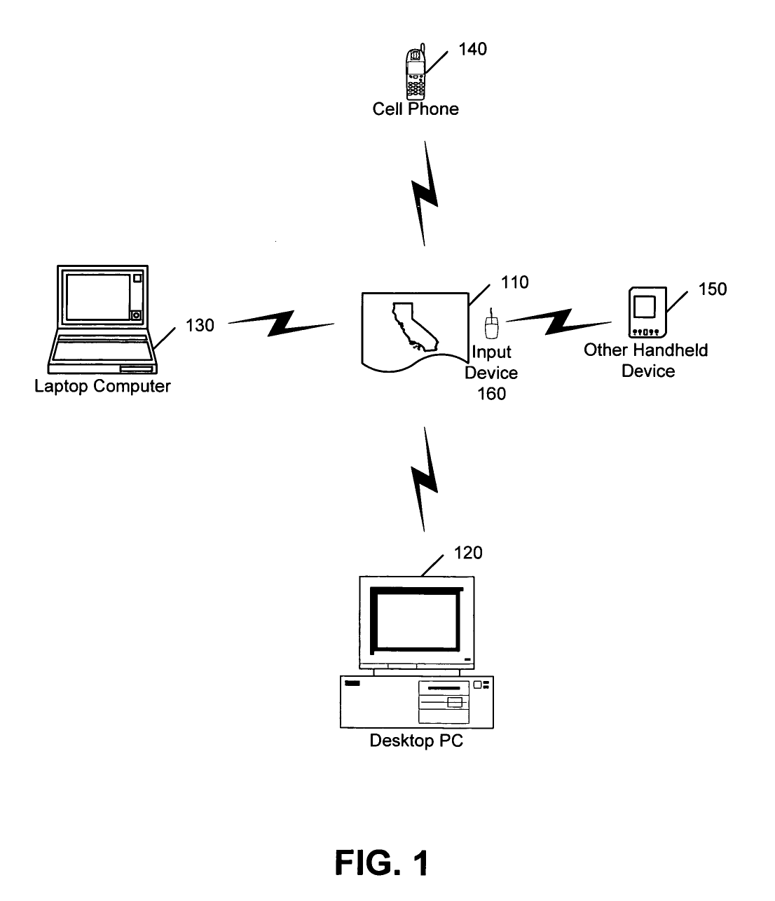

FIG. 1 illustrates an exemplary operating environment for applying the various exemplary embodiments described herein.

In FIG. 1, digital content (e.g., a digital image or other form of document) can be displayed or otherwise made available on a computing device, such as desktop PC 120, laptop computer 130, cell phone 140, other handheld device 150, and/or still other computing devices.

In an exemplary implementation, a representation of the digital content may be represented on a tangible medium 110 to assist with navigation of the digital content on the computing device. As used herein, the term navigation includes not only roaming through the digital content, but also related aspects such as accessing, processing, and/or displaying the digital content. As an example, if a digital document contains information relating to the state of California, a tangible medium representing California may be used to assist digital navigation of the digital document.

In an exemplary implementation, the computing device (e.g., the desktop PC 120) includes a CPU and a memory for executing logic instructions to perform various exemplary processes to be described below in Sections III-VIII. Those skilled in the art will readily appreciate that fewer or more components may be implemented for performing the exemplary processes, and that one or more components of the computing device may reside in the same computer or in different computers coupled to each other or in a distributed computing environment. The computing device may or may not be connected to a network, such as a local-area-network (LAN) (e.g., an intranet) and/or a wide-area-network (WAN) (e.g., the Internet).

In an exemplary implementation, the tangible medium may be generated upon request by the user. In another exemplary implementation, the tangible medium may be automatically generated when the user attempts to navigate certain digital content (e.g., by opening a document). In the latter implementation, the tangible medium may be generated every time the digital content is accessed, the first time the digital content is accessed, or upon satisfying some other threshold condition. Exemplary techniques for generating a tangible medium will be described in more detail in Section III below. Alternatively, the tangible medium could be preexisting (i.e., previously generated, independent of the navigation techniques disclosed herein).

After a tangible medium representing certain digital content is generated, a user can navigate the digital content on a computing device using the tangible medium 110 and an input device 160. An exemplary embodiment of using the tangible medium to assist navigation of digital content will be described in more detail in Sections IV through VIII below.

In an exemplary embodiment, the input device 160 is user-positionable and may be used for selection of digital content by using the tangible medium as well as browsing of the selected digital content on a computer screen. For example, the input device 160 can be configured to enable a user to toggle between a selection mode and a selected digital content browsing mode. In one implementation, the input device 160 may include a button that toggles between different modes each time it is pressed by a user. Alternatively, different input devices could be used for selection on the tangible medium versus digital browsing of the selected content, so that it is not necessary to switch between modes for any particular input device.

Various commercially available input devices can be used with the techniques disclosed herein. The particular choice will depend on the particular technique used to read the tangible medium. For example and without limitation, these might include an optical mouse, a stylus, a handheld scanner, a magnetic ink reader, a radiofrequency (RF) scanner, an ultrasonic sensor, and still others. Some input devices may have multiple components. For example, a digitizing tablet would include an electronic tablet together with a pen (or cursor or puck).

B. An Exemplary Computing Environment

The techniques described herein can be implemented using any suitable computing environment. The computing environment could take the form of software-based logic instructions stored in one or more computer-readable memories and executed using a computer processor. Alternatively, some or all of the techniques could be implemented in hardware, perhaps even eliminating the need for a separate processor, if the hardware modules contain the requisite processor functionality. The hardware modules could comprise PLAs, PALs, ASICs, and still other devices for implementing logic instructions known to those skilled in the art or hereafter developed.

In general, then, the computing environment with which the techniques can be implemented should be understood to include any circuitry, program, code, routine, object, component, data structure, and so forth, that implements the specified functionality, whether in hardware, software, or a combination thereof. The software and/or hardware would typically reside on or constitute some type of computer-readable media which can store data and logic instructions that are accessible by the computer or the processing logic. Such media might include, without limitation, hard disks, floppy disks, magnetic cassettes, flash memory cards, compact discs, digital video discs, removable cartridges, random access memories (RAMs), read only memories (ROMs), and/or still other electronic, magnetic and/or optical media known to those skilled in the art or hereafter developed.

III. An Exemplary Process for Generating a Tangible Medium

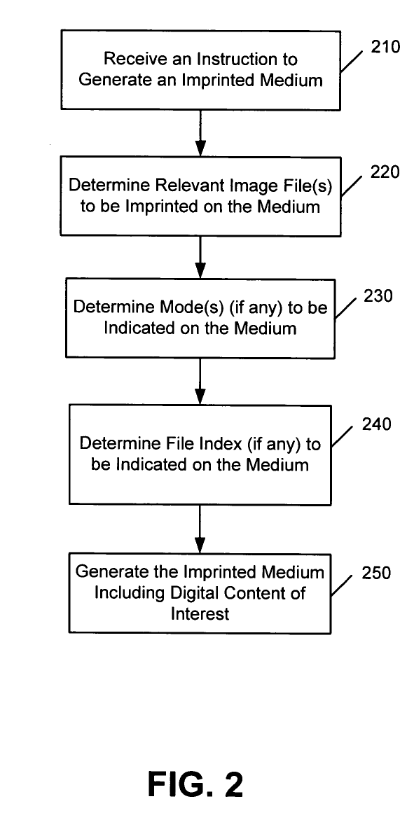

FIG. 2 illustrates an exemplary process for generating a tangible medium 110 representing digital content that may be navigated (in whole or in part) by a user. For the sake of illustration, the digital content and navigation thereof will be described with respect to image data (still images, video, etc.).

At step 210, an instruction to generate a tangible medium is received by computing device 120. The computing device may process the request locally or forward the request to a remote computer (not shown) via a LAN or WAN. In an exemplary implementation, the instruction to generate the tangible medium could include a user-generated request sent via input device 160, a keyboard (not shown), or still other external devices. Or, the instruction could be generated by a software program monitoring the user's digital content access activity. For example, the tangible medium may be generated the first time the digital content is accessed, every time the digital content is accessed, or upon satisfying some other threshold condition. Alternatively, the tangible medium may be generated based on detecting an indication that the user wishes to perform a navigation operation.

At step 220, the computing device determines the relevant image file (or files) needed to be tangible on the medium. For example, if the user requests to navigate travel information about California, the relevant overview might be a map of the state of California. In general, the file(s) to be tangible could include those being viewed by the user, or a superset thereof. Or, if no file is currently being viewed (i.e., the tangible medium is being generated in anticipation of future use), these could include any user-specified file or files.

At step 230, the computing device determines one or more modes to be indicated on the tangible medium. For example, when navigating a map, suitable modes might include, without limitation, translational movements, zoom-in/out capabilities, rotational capabilities, etc. The modes could be specified by default, by the user, automatically based on the type of content being viewed, or otherwise.

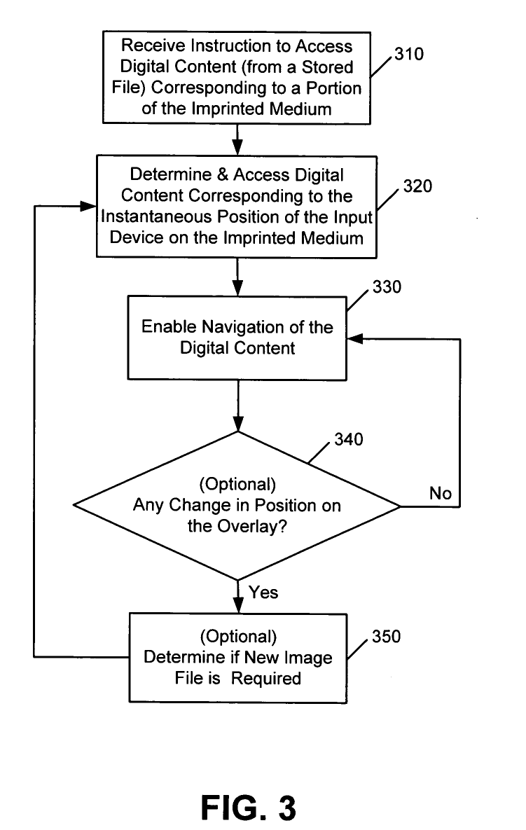

At step 240, the computing device determines a file index (if any) to be indicated on the tangible medium. The file index may later be used (e.g., during the process shown in FIG. 3) to determine which file should be retrieved for use during navigation. Suitable forms of file indexes may include file names, numbers, bar codes, and any other form of human-or machine-readable indicia.

At step 250, the computing device creates the tangible medium by generating a representation of the digital content to be tangible, and sending the content to a suitable output device based on the type and format of the medium. In one exemplary implementation using paper as the medium, the computing device is connected to a conventional printer. Still other forms of tangible medium might include transparent overlays, plastic sheets, stickers, and virtually any other form of tangible medium (including three-dimensional articles). One skilled in the art will recognize that still other tangible media may be used in accordance with various embodiments described herein. The choice of medium will depend on design factors such as cost, convenience, size, durability, available writing and/or reading technologies, and/or still other factors.

IV. An Exemplary Process for Navigating Digital Content Using a Tangible Medium

FIG. 3 illustrates an exemplary process for navigating digital content using a tangible medium.

At step 310, the computing device receives an instruction to access digital content (to be retrieved from a stored file) corresponding to a specified portion of the tangible medium. For example, a user moving the input device 160 over the tangible medium could click a button on the input device (e.g., a mouse button) to indicate when he wishes to view digital content corresponding to that instantaneious position selected by the input device. Of course, the instruction need not be affirmatively generated by the user. For example, an access instruction could be automatically generated each time the user stops moving the input device for a predetermined threshold of time, or a sequence of signals could be generated at short intervals (e.g. every tenth of a second), or otherwise.

At step 320, digital content corresponding to the user's instantaneous position on the tangible medium is determined and accessed. In general, this step involves finding the appropriate digital image files (or portions thereof) corresponding to where the user has positioned the input device on the tangible medium. Various exemplary embodiments for executing this step will be described in Sections V, VI and VII below.

At step 330, navigation of the digital content is enabled. In an exemplary implementation, a user may use the same input device, as was used to physically browse the tangible medium, to navigate the digital content on a computer screen. In another implementation, the user may use a separate input device (not shown) to navigate the digital content. A wide variety of navigation techniques are well known in the art, and need not be described in detail here.

At (optional) step 340, the computing device determines whether the user has changed the position of the input device on the tangible medium (e.g., did the user move his mouse?). Techniques for detecting movement are generally available in the drivers and other software programs distributed with input devices (e.g., a mouse driver) and need not be described in detail herein.

At (optional) step 350, if there has been any change in position, then the computing device determines whether a new image file is required. For example, as a user viewing a city map moves his input device across the city, additional neighborhood maps may have to be loaded.

At step 360, if there has not been any change in position, then the process returns to step 330 to await additional user navigation operations.

V. Determining Digital Content Corresponding to a Position on the Tangible Medium Using Pattern Matching

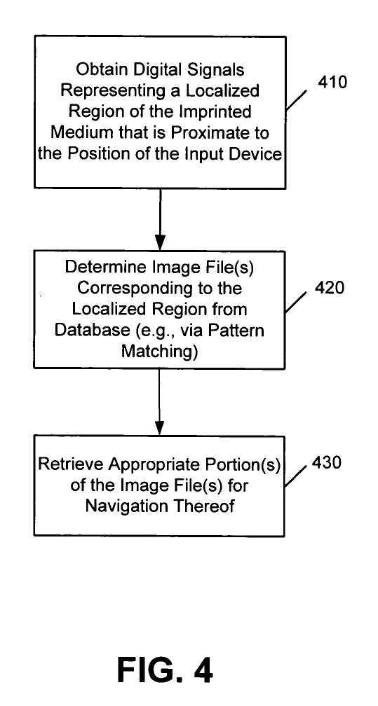

After a tangible medium (e.g., a sheet of paper) bearing a representation of digital content has been generated, a user may utilize the tangible medium to assist the navigation of the digital content on a computing device. As indicated at step 320 of FIG. 3, such navigation involves determining the specific digital content (e.g., stored in a memory or database accessible to the computing device) corresponding to the instantaneous position of the user's input device 160 on the tangible medium. FIG. 4 illustrates one exemplary embodiment using pattern matching techniques for determining corresponding digital content from stored files.

At step 410, the computing device obtains digital signals representing a localized region of the tangible medium that is proximate to the position of the input device. For example, the signals might represent an image of the localized region. The size, shape and location of the localized region will depend on the characteristics of the input device, and the design characteristics of the pattern matching software.

In one exemplary implementation, consider an optical input device having a sensor. Depending on design, the sensor may be very small (e.g., the cross-hairs of a cursor for a digitizing tablet), or it may be larger (e.g., a LED sensor of an image-capturing optical mouse). If the sensor is large enough to capture sufficient detail from the tangible medium to allow pattern matching, then a single sensor reading, taken around the instantaneous position of the input device at any given time, can be used. Conversely, if the sensor is too fine to capture sufficient detail in a single reading, then multiple readings, taken as the input device is being moved by the user, can be aggregated to provide the image of the localized region. For example, such multiple readings might span a portion of the trail or path traversed by the user while moving the input device just prior to reaching a particular point of interest. Alternatively, the user might be directed to move the input device in a circular, to-and-fro, or other pattern, thereby allowing the sensor to capture multiple readings near the position of interest.

At step 420, the computing device determines which of its stored image files corresponds to the image of the localized region. For example, commercially available pattern matching algorithms can be used to correlate the image of the localized region against each of the files, in turn, and to determine which file (or files) gives the best match (e.g., in a least-squares sense) to the image of the localized region.

At step 430, the appropriate portions of the file(s) are then retrieved to enable user navigation.

The pattern matching embodiment of FIG. 4 is generally applicable to digital content of all types, since it depends only on being able to uniquely resolve a portion of the tangible medium and search for a match among the stored image files. Such pattern matching technology is especially well suited to digital content that contains a substantial amount of machine-discernible variations (e.g., in texture, contrast, color, etc.).

It is not even necessary that the tangible medium and the stored files have originated from the same source (although that would often be the case). For example, most maps of the same region could be expected to contain the same major streets (e.g., indicated by dark lines on a lighter background). Therefore, in a road mapping implementation, pattern matching could be implemented across maps from different vendors. That is, the tangible image could originate from one supplier, and the stored image files being navigated could originate from a totally unrelated supplier.

VI. Determining Digital Content Corresponding to a Position on the Tangible Medium Using Coordinate Mapping

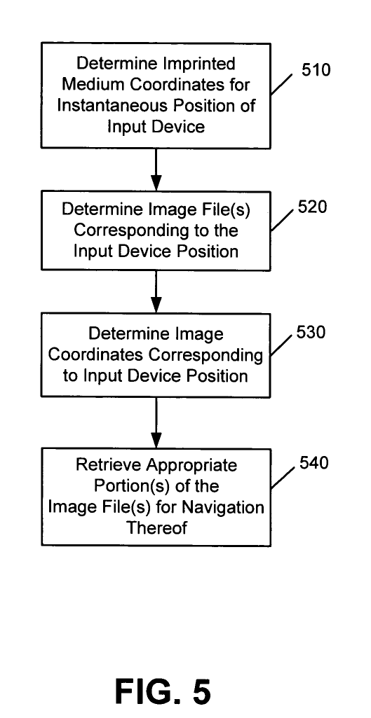

FIG. 5 illustrates another exemplary embodiment using coordinate mapping for determining corresponding digital content in stored files. This technique requires that locations in both the tangible medium and the stored files be representable in their respective coordinate systems, and that the coordinate systems have a known (or determinable) relationship to one another.

At step 510, the computing device determines the coordinates, in the coordinate system of the tangible medium, of the instantaneous position of the input device. For example, if the coordinate system is Cartesian and given by (x_{IM}, y_{IM}), then a point of interest (denoted by *) might be denoted by (x_{IM}*, y_{IM}*).

Techniques for determining coordinates are well known in the art, and need not be described in detail herein. As one exemplary embodiment, consider the use of a digitizing tablet and puck. The puck is similar to a mouse, except that it has a window with cross hairs for pinpoint placement. In one exemplary implementation, the tangible medium is a sheet of paper (or some form of overlay) of known size, that can be affixed to the digitizing tablet. The user is prompted to pick multiple (say, three) corners of the tangible medium, thereby establishing the coordinate system. For example, consider a sheet of paper of size 8.5 inches by 11 inches, and which is placed in landscape orientation on the digitizing tablet. If the user is prompted to pick the upper left, lower left, and lower right corners, the digitizing software can readily establish that these correspond to (x_{IM}, y_{IM})=(0, 8.5), (0,0) and (11,0), respectively. Then, the coordinates of any other point at the interior of the paper can be established by simple interpolation.

As another exemplary implementation, the paper is placed on an electronic tablet, and the instantaneous position of a pen (or other form of stylus or pointing device) on the tablet is tracked using ultrasonic or other form of radio frequency signals using one or more transmitter(s) and receiver(s). This type of technology is currently commercially available, for example, as implemented in Seiko's Inklink handwriting capture system, and can readily be adapted to perform the coordinate determinations used herein.

At step 520, the computing device determines the stored image file (or files) corresponding to the image of the localized region. For example, indexing information could have been recorded in a look-up table during creation of the tangible medium, with indexing occurring by city name, by a file number recorded on the tangible medium, or otherwise. In general, any suitable technique can be used for looking up the stored file(s). Of course, if there is a single default stored image file this step can be omitted.

At step 530, the computing device determines the coordinates, in the coordinate system of the stored image file, corresponding to the instantaneous position of the input device. For example, if the stored file coordinate system is Cartesian and given by (x_{F}, y_{F}), then it can be mathematically related to the tangible medium coordinate system by the linear transformation
x_{F}=ax_{IM}+by_{IM}
y_{F}=cx_{IM}+dy_{IM}
or, conversely,
x_{IM}=(dx_{F}−by_{F})/(ad−bc)
y_{IM}=(−cx_{F}+ay_{F})/(ad−bc)
where the mapping constants a, b, c & d account for differences in translation, rotation, and magnification between the two coordinate systems.

These constants may have been determined previously, for example, during creation of the tangible medium from the stored image files (e.g., as a corollary to the exemplary process of FIG. 2). But even if the mapping constants are not known beforehand, they can be readily determined by mathematically calibrating the tangible medium to the stored file. For example, this could be done by prompting the user to click on known reference markers (e.g., small crosses identifying multiple corners of the image) corresponding to similar reference markers in the image file. By clicking on a plurality of such markers, and knowing their coordinates in both the tangible medium and the image file, the mapping constants a, b, c & d can be readily determined. These and other exemplary techniques for calibration are well known in the art and need not be described in detail herein.

Having the mapping coordinates a, b, c & d, and a point of interest in the tangible medium (x_{IM}*, y_{IM}*), the corresponding point of interest in the stored image file can be determined as
x_{F}*=ax_{IM}+by_{IM}
y_{F}=cx_{IM}+dy_{IM}*.

Finally, at step 540, an appropriate portion of the stored image file (for example, centered about the coordinates (x_{F}*, y_{F}*)) can be retrieved and made available (e.g., displayed) for navigation.

In the foregoing, it should be noted that it is not necessary for each point in the tangible medium (and in the stored file) to be representable by a unique coordinate pair (x,y). For example, the images could be divided into relatively coarse grids with each grid containing a plurality of points. For example, in an electronic analog to paper road maps, the vertical axis could be denoted by letters, and the horizontal axis denoted by letters, so that each grid on the map is represented by a pair such as B6 (representing row 2, column 6). Knowing that the user is interested in a point within grid B6 on the tangible medium, it is only necessary to find the corresponding grid on the stored image file. This relatively coarse mapping could even be performed using a simple look up table rather than the linear transformation set forth above.

VII. Determining Digital Content Corresponding to a Position on the Tangible Medium Using a Hybrid of Pattern Matching and Coordinate Mapping

The foregoing two sections illustrated the use of pattern matching and coordinate mapping, respectively, to determine digital content corresponding to a position on the tangible medium. Pattern matching and coordinate mapping may also be used together, in a hybrid scheme, as follows.

In an exemplary implementation, the representation of digital content is printed on (or otherwise affixed to) a specialized medium which contains an unique machine-readable pattern for each point within the medium itself (as opposed to content tangible on the medium). For example, the Anoto paper developed by Anoto (www.anoto.com) contains special patterns that may be captured and decoded by a commercially available Anoto-enabled input device (e.g., io personal digital pen by Logitech). Then, any location on an Anoto paper can be readily determined in the coordinate system of the tangible medium.

Having discerned the coordinates of the position of the input device, the corresponding coordinates of the stored image file can be mapped using the techniques set forth in Section VI above, and the appropriate portions of the stored image file retrieved for user navigation.

All of the exemplary processes described in Sections V, VI and VII above are merely illustrative. Those skilled in the art will recognize that still other processes for determining content corresponding to a position on a tangible medium may also be implemented in accordance with design choice, available technology, and/or other considerations.

VIII. Other Aspects and Considerations

A. Mode Toggling

After determining the appropriate digital content, the computing device will enable the user to navigate the digital content on a computer screen using an input device connected to the computing device. For example, if the same input device is used for both browsing the tangible medium and navigating the digital content, the user may use a button on the input device to toggle between media browsing and content navigation modes. In another example, the user may use a separate input device to navigate the digital content. Either way, there may be various navigation modes available to the user.

In an exemplary implementation, the available modes may be represented on the tangible medium. For example, a navigation session through a map may require toggling between translational movements, zooming capabilities, etc. The one or more modes may be represented by icons, barcodes, text and/or still other human- or machine-readable identifiers. To access a mode using a machine-readable identifier, the user may move the input device to the location of an identifier representing a desired mode. Depending on configuration, the computing device may scan the identifier and automatically toggle to the desired mode, or the computing device may toggle to the desired mode upon receipt of an input (e.g., a button click) from the user. In an exemplary implementation, the mode identifiers may themselves be scanned by the input device, and recognized using the exemplary pattern matching and/or coordinate mapping techniques disclosed above. Each identifier may even include multiple modes.

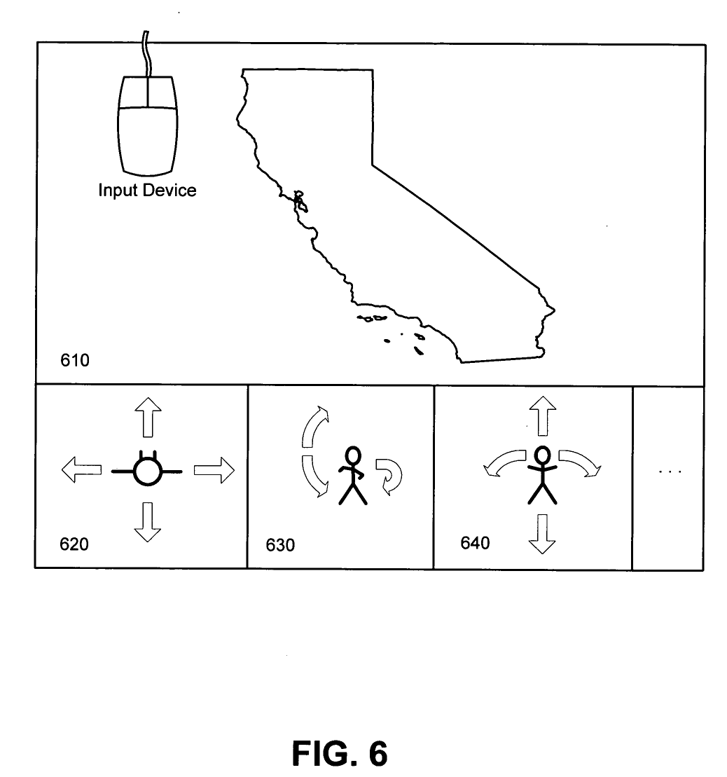

For example, FIG. 6 illustrates an exemplary tangible medium including an area 610 containing an overview of the state of California, and a series of mode identifiers in the form of icons 620, 630 & 640. The exemplary mode icons, representing possible movements of a human avatar, will be described in greater detail in Section VIII.B below.

Those skilled in the art will readily recognize that other implementations of mode toggling may be used in accordance with design choice, available technology and/or other considerations.

B. Three-Dimensional Navigation

In an exemplary implementation, a tangible medium may also be used to assist navigation of digital content representing a three-dimensional environment (e.g., a three-dimensional map, video game, etc.). Many forms of tangible medium can be used to represent a three-dimensional environment. For example, a two-dimensional tangible medium (such as an overhead view) can be overlaid with contours representing lines of constant elevation (e.g., as in a topographic contour map). Any point within such a two-dimensional tangible image actually represents a three-dimensional location that can be navigated using the appropriate three-dimensional image files. Alternatively, multiple two-dimensional tangible media can be used to aid three-dimensional navigation. For example, one medium might indicate a plan view, while another indicates a side view. As yet another alternative, the tangible medium need not be two-dimensional, but could itself be three-dimensional. For example, the tangible medium could be an image tangible onto an underlying three-dimensional surface (e.g., a miniature rendering of some physical subject matter of interest).

In a three-dimensional environment, the user may have more navigational options compared to a two-dimensional environment. For example, in a three-dimensional video game, a user may need to move forward/backward, up/down, right/left, as well as rotate along any of three orthogonal axes (e.g., roll, pitch and/or yaw), at any given time. In one implementation, various degree-of-freedom control pairs may be represented on a tangible medium as mode icons.

FIG. 6 depicts an exemplary implementation where the tangible medium is a two-dimensional sheet, on which are printed multiple exemplary mode icons selectable by an input device. Each exemplary icon includes two possible degrees of freedom (represented by arrows) corresponding to two distinct simulated motions. In this exemplary embodiment, it is convenient (although not necessary) to use 2 degrees of freedom per icon, because two user motions (e.g., left-right and up-down) can be readily distinguished by the input device. Thus, one such degree of freedom can be triggered by up/down movement of the input device, and another such degree of freedom can be triggered by left/right movement of the input device.

Exemplary icon 620 illustrates (from a top view) a mode including forward/backward and left/right translation. Exemplary icon 630 illustrates a mode including pivoting of the torso, and tilting of the head up/down. Exemplary icon 640 includes tilting of the head left/right, and climbing/descending. Still other motions can be represented (in any combination) using these kinds of icons, with the possible choices including, without limitation: (a) body motion forward/backward; (b) body motion left/right; (c) body motion up/down; (d) body or head tilting up/down; (e) body or head tilting left/right; and (f) body or head twisting left/right. In general, the particular combination of motions, to be represented on any particular icon, could be either user-specified (e.g, as an optional step performed during generation of the tangible medium), or preprogrammed.

Of course, many other forms of icon could also be used instead of the human avatar shown. For example, if the icon represented a submarine (or some other vehicle) instead of a human, the corresponding motions would be: (a) movement ahead/astern; (b) movement to port/starboard; (c) ascent/descent; (d) pitching; (e) rolling; and (f) yawing.

In yet another implementation, the user may use a separate input device (e.g., a joystick) which allows better movement control when navigating in a three-dimensional digital environment.

C. Portable Navigation Devices

As indicated by Section II.A, the techniques disclosed herein are widely applicable in a variety of applications beyond just conventional computer devices (such as desktop computers).

As just one example, many modern cell phones 140 include both a browser and a digital camera. In such a cell phone, the digital camera could be used as an input device to scan a tangible medium (e.g., a map), and the browser could be used to navigate the digital content resulting therefrom. The computational operations needed to determine the digital content corresponding to the tangible medium could be performed by a microprocessor in the phone itself, or remotely over the cell phone network. In this manner, a cell phone might be adapted to form a new type of navigation aid.

As another example, a handheld GPS device containing a display screen (e.g. used by a hiker) could be adapted to include an optical scanner that allows the user to select a portion of a topographic map of interest (perhaps a waypoint for a hike). The user could then be presented with images of the path to be followed to get from the current location to the desired destination.

The foregoing examples illustrate the general concept of adapting existing consumer devices to provide the user with enhanced navigation capabilities, without requiring the user to carry an additional device.

D. Non-Image Files

In many of the foregoing exemplary embodiments and implementations, the digital content has been described as image data, and the files have been described as image files (e.g., still and video images). However, those skilled in the art will readily appreciate that the techniques described herein can readily be applied to other forms of digital content as well. For example, the digital content could be audio (e.g., music, songs, speech, etc.), and the navigation of such audio could include playback operations. As yet another example, the digital content could include a text document, to be visually displayed to the user, or to be played back to the user via a commercially available speech simulator (e.g., software and sound card deployed in a microcomputer).

In still another example, the digital content could include image and audio (or text) data, with an improved form of video storyboard serving as the corresponding tangible medium. A video storyboard is an outline of a video (motion picture, etc.) showing, for each scene in the video, the images and corresponding audio (or text) to be displayed. Traditionally, video storyboards have been printed on cardstock, and are inherently non-functional (i.e., the user can not access a scene of interest from the storyboard itself). Recently, electronic video storyboards have also become available (e.g., the “scene selection menu” in a DVD movie). Such wholly electronic storyboards do away with the cardstock, instead utilizing the same screen for the storyboard and the digital content. The improved storyboard implemented using the techniques disclosed herein combines the advantages of purely paper-based storyboards and purely electronic storyboards.

### IX. Conclusion

The foregoing examples illustrate certain exemplary embodiments from which other embodiments, variations, and modifications will be apparent to those skilled in the art. The inventions should therefore not be limited to the particular embodiments discussed above, but rather are defined by the claims. Furthermore, if any claims include alphanumeric identifiers to distinguish the elements and/or recite elements in a particular sequence, it should be understood that such identifiers or sequence are merely provided for convenience in reading, and should not necessarily be construed as requiring or implying a particular order of steps, or a particular sequential relationship among the claim elements. Finally, any references to an example, or to the term “including” (including all variants thereof), should not be limited to the specific embodiments, implementations, or details disclosed unless clearly indicated by the context in which the reference is made.

1. A method for assisting navigation of digital content using a tangible medium, comprising:
receiving an instruction to access digital content corresponding to a portion of a tangible medium:
said medium being readable by a user-positionable input device, and
said digital content being accessible from a stored file;
determining and accessing stored digital content corresponding to said user's instantaneous position on said tangible medium; and
enabling electronic navigation of said digital content.

2. The method of claim 1, further comprising:
determining a change in position of said input device on said tangible medium; and
obtaining a new stored file corresponding to said change in position.

3. The method of claim 1, wherein said determining and accessing stored digital content includes:
obtaining digital signals representing a localized region of said tangible medium, said localized region being proximate to said position of said input device on said tangible medium;
determining at least one stored file corresponding to said localized region, and containing said digital content, by using pattern matching; and
retrieving an appropriate portion of said file to enable user navigation.

4. The method of claim 3, wherein said pattern matching is based on correlating a pattern within said localized region with a pattern in said stored file.

5. The method of claim 3, wherein said pattern matching is based on correlating a pattern embedded within said medium itself.

6. The method of claim 3, wherein said tangible medium was previously created independently of said file.

7. The method of claim 1, wherein said determining and accessing stored digital content includes:
obtaining coordinates of said position of said input device on said tangible medium;
determining at least one stored file corresponding to said position and containing said digital content;
determining coordinates within said stored file, corresponding to said input device position coordinates, by using coordinate mapping; and
using said determined coordinates to retrieve an appropriate portion of said file to enable user navigation.

8. The method of claim 7, wherein said coordinate mapping involves a linear transformation from tangible medium coordinates to stored file coordinates.

9. The method of claim 7, wherein at least one of said tangible medium and said stored file includes a grid system.

10. The method of claim 7, wherein said determining said stored file includes utilizing a file index read from said tangible medium.

11. The method of claim 7, wherein said file index was previously generated during creation of said tangible medium.

12. The method of claim 7 wherein;
said tangible medium includes a plurality of machine-readable patterns embedded in said medium itself;
said obtaining coordinates of said position of said input device is based on reading a unique pattern at said position of said input device, and analyzing said unique pattern to determine said coordinates.

13. The method of claim 1, wherein said digital content includes an image, and said navigation includes displaying said image.

14. The method of claim 1, wherein said digital content includes audio, and said navigation includes playing said audio.

15. The method of claim 1, wherein said tangible medium serves as a video storyboard.

16. The method of claim 1, wherein said navigation includes at least one user-selectable mode.

17. The method of claim 16, wherein said modes are designated on, and selectable from, said tangible medium.

18. The method of claim 1, wherein said tangible medium includes paper.

19. The method of claim 1, wherein said input device includes an optical device.

20. The method of claim 1, wherein said input device includes a radio frequency device.

21. The method of claim 1, wherein said tangible medium is two-dimensional, yet includes three-dimensional information.

22. The method of claim 1, further comprising using multiple tangible media to facilitate three-dimensional navigation.

23. The method of claim 1, wherein said tangible medium was previously created using said stored file.

24. The method of claim 1 implemented in a handheld portable electronic device.

25. A computer-readable medium for assisting navigation of digital content using a tangible medium, comprising logic instructions that when executed:
receive an instruction to retrieve digital content corresponding to a portion of a tangible medium:
said medium being readable by a user-positionable input device; and
said digital content being accessible from a stored file;
determine and retrieve stored digital content corresponding to said user's instantaneous position on said tangible medium; and
enable electronic navigation of said digital content.

26. The computer-readable medium of claim 25, wherein said logic instructions that determine and retrieve stored digital content include logic instructions that when executed:
obtain digital signals representing a localized region of said tangible medium, said localized region being proximate to said position of said input device on said tangible medium;
determine at least one stored file corresponding to said localized region, and containing said digital content, by using pattern matching; and
access an appropriate portion of said file to enable user navigation.

27. The computer-readable medium of claim 25, wherein said logic instructions that determine and retrieve stored digital content include logic instructions that when executed:
obtain coordinates of said position of said input device on said tangible medium;
determine at least one stored file corresponding to said position and containing said digital content;
determine coordinates within said stored file, corresponding to said input device position coordinates, by using coordinate mapping; and
use said determined coordinates to access an appropriate portion of said file for navigation by said user.

28. A system for assisting navigation of digital content using a tangible medium, comprising:
means for receiving an instruction to access digital content corresponding to a portion of a tangible medium:
said medium being readable by a user-positionable input device; and
said digital content being accessible from a stored file;
means for determining and accessing stored digital content corresponding to said user's instantaneous position on said tangible medium; and
means for enabling electronic navigation of said digital content.

29. A system for assisting navigation of digital content using a tangible medium, comprising:
an interface configured to receive an instruction from an input device to access digital content corresponding to a portion of a tangible medium:
said medium being readable by said input device; and
said digital content being accessible from a stored file; and
a processor configured to:
determine and access digital content corresponding to said user's position on said tangible medium, and
enable electronic navigation of said digital content.

30. The system of claim 29, wherein said processor is further configured to:
obtain digital signals representing a localized region, of said tangible medium, that is proximate to said position of said input device on said tangible medium;
determine at least one stored file corresponding to said localized region, and containing said digital content, by using pattern matching; and
retrieve an appropriate portion of said file for user navigation.

31. The system of claim 29, wherein said processor is further configured to:
obtain coordinates of said position of said input device on said tangible medium;
determine at least one stored file corresponding to said position and containing said digital content;
determine coordinates within said stored file, corresponding to said input device position coordinates, by using coordinate mapping; and
access an appropriate portion of said file based on said determined coordinates to enable user navigation.
